(19) United States
(12) Patent Application Publication
(10) Pub. No.: US 2016/0352118 A1
(43) Pub. Date: Dec. 1, 2016

(54) COMBINATION STORAGE RACK AND CHARGER FOR TABLET COMPUTERS AND SMARTPHONES

(71) Applicant: Cheng Yu Huang, New Taipei (TW)

(72) Inventor: Cheng Yu Huang, New Taipei (TW)

(21) Appl. No.: 14/726,711

(22) Filed: Jun. 1, 2015

(30) Foreign Application Priority Data
May 26, 2015 (TW) 104208101

(51) Int. Cl. H02J 7/00

(52) U.S. Cl. CPC H02J 7/0044; H02J 7/0013; H02J 7/0052; H02J 2007/0062

(57) ABSTRACT

A combination device includes a charger including a socket and USB ports; holders each including a lengthwise groove; block members each configured to insert into the USB port; joining members each including two sets of first and second axes wherein the first axes are pivotably secured to the holder and the second axes are pivotably secured to the adjacent holder; first and second hinges each including a first part having two axes and a pivot, and a second part having two axes and a hole for receiving the pivot. The first part of the first hinge and a corner of the charger are hinged and the second part thereof and a corner of the adjacent holder adjacent are hinged. The first part of the second hinge and a corner of the holder are hinged and the second part thereof and a corner of the distal holder are hinged.

### BACKGROUND OF THE INVENTION

1. Field of the Invention

The invention relates to storage rack and more particularly to a combination storage rack and charger for tablet computers and smartphones.

2. Description of Related Art

Smartphones and tablet computers are widely used throughout the world. They are lightweight and compact. However, its operating time is limited. Thus, charging is often for frequent users. Storage of the smartphone or the tablet computer is another issue. Conventionally, a user may have a charger and a separate holder if he or she has a smartphone or tablet computer. This is not inconvenient in use. Further, it may become messy if an individual has several smartphones and tablet computers.

Thus, a combination storage rack and charger for tablet computers and smartphones is constantly sought.

### SUMMARY OF THE INVENTION

It is therefore one object of the invention to provide a combination storage rack and charger comprising a parallelepiped charger including a socket and a plurality of USB ports; a plurality of holders each including a central, lengthwise groove and an inclined trough on a surface of the groove; a plurality of block members each including a wedge and a peg configured to insert into the USB port; a plurality of joining members each including two sets of first and second axes wherein the first axes are pivotably secured to the holder and the second axes are pivotably secured to the adjacent holder; first and second hinges each including a first part having two axes and a pivot, and a second part having two axes and a hole; wherein the pivot is pivotably disposed in the hole; wherein the first part of the first hinge is hingedly secured to a corner of the charger and the second part thereof is hingedly secured to a corner of the holder adjacent to the charger; and wherein the first part of the second hinge is hingedly secured to a corner of the holder and the second part thereof is hingedly secured to a corner of the holder distal the charger.

The above and other objects, features and advantages of the invention will become apparent from the following detailed description taken with the accompanying drawings.

### BRIEF DESCRIPTION OF THE DRAWINGS

FIG. 1 is a perspective view of a combination storage rack and charger according to the invention;

FIG. 2 is another perspective view of the combination storage rack and charger with a tablet computer held thereon for charging;

FIG. 3 is another perspective view of the combination storage rack and charger with five tablet computers held thereon for charging;

FIG. 4 is another perspective view of the combination storage rack and charger and the tablet computers shown in FIG. 3;

FIG. 5 is a perspective view of the combination storage rack and charger arranged as a straight line;

FIG. 6 is a perspective view of the combination storage rack and charger arranged as a U;

FIG. 7 is a view similar to FIG. 6 with a tablet computer held thereon;

FIG. 7A is a perspective view of the joining member;

FIG. 8 is a view similar to FIG. 7 showing pivotal movements of the distal holder and the charger;

FIG. 8A is a perspective view showing a pivotal movement of the first hinge part relative to the second hinge part;

FIG. 8B is an exploded view of FIG. 8A showing the first and second hinge parts to be assembled; and

FIG. 9 is a perspective view of four combinations storage rack and charge arranged as a straight line.

### DETAILED DESCRIPTION OF THE INVENTION

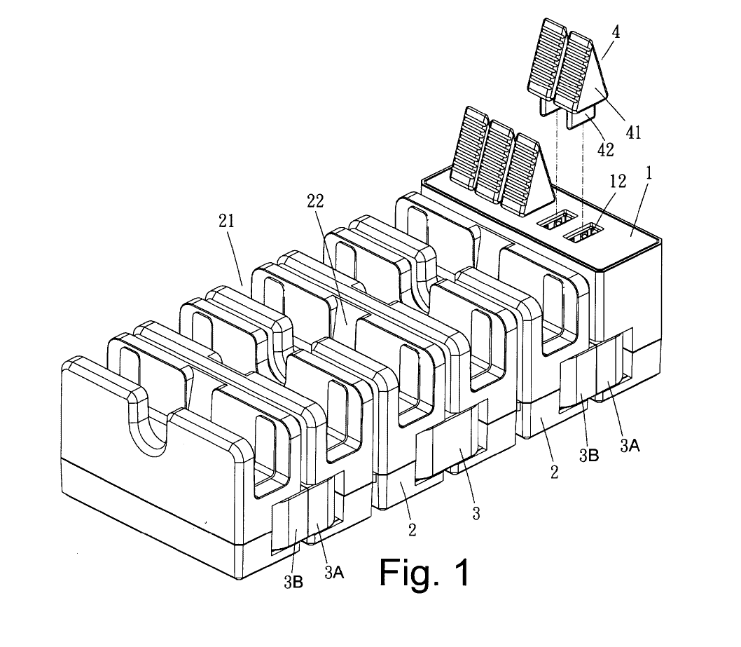

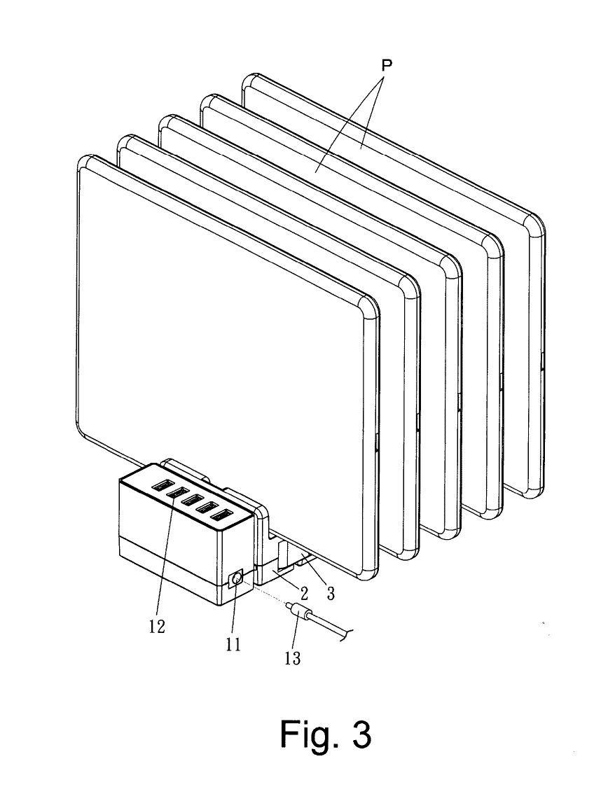

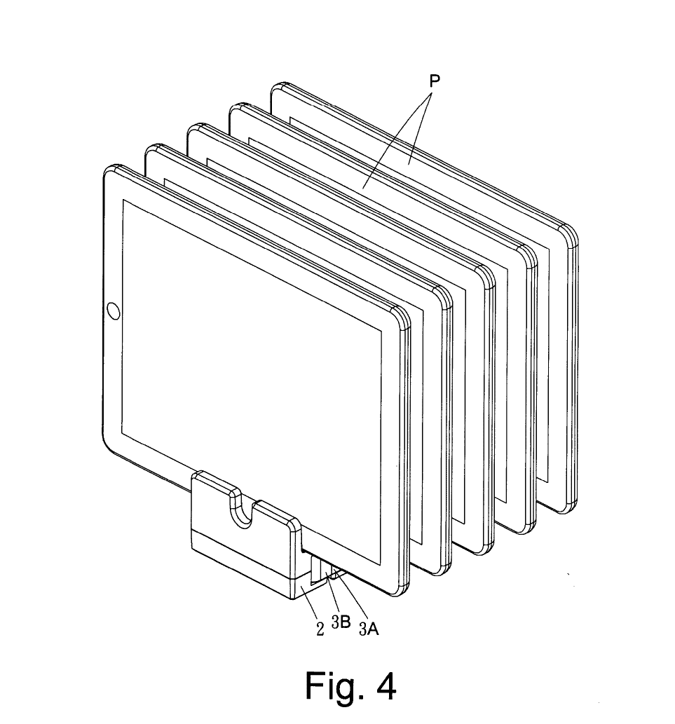

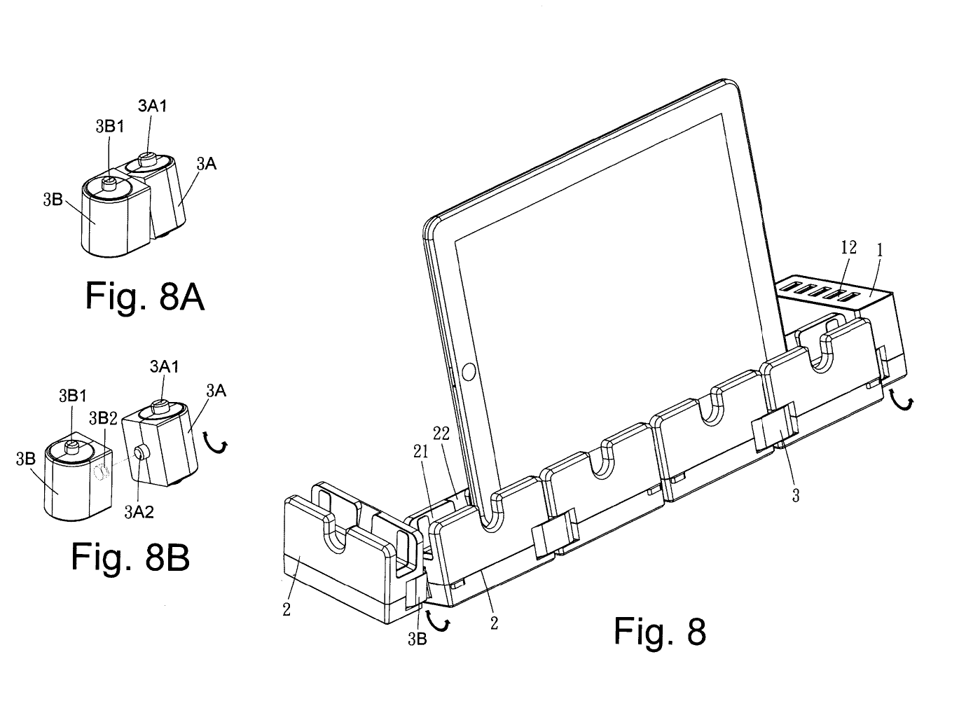

Referring to FIGS. 1 to 9, a combination storage rack and charger for tablet computers and smartphones in accordance with the invention comprises a charger 1, a plurality of holders 2, two pairs of first hinge part 3A and second hinge part 3B, a plurality of joining members 3, and a plurality of block members 4 as discussed in detail below.

The parallelepiped charger 1 includes a socket 11 on one side and a plurality of USB (Universal Serial bus) ports 12 on a top. DC (direct current) power can be supplied to the charger 1 by inserting a DC connector 13 into the socket 11. A smartphone or a tablet computer can be charged by inserting a USB plug thereof into the USB port 12.

The joining member 3 includes two sets of first and second axes 31, 32 on top and bottom respectively. The first axes 31 are pivotably secured to one holder 2 and the second axes 32 are pivotably secured to an adjacent holder 2. The first hinge part 3A includes two axes 3A1 on top and bottom respectively, and a pivot 3A2 on one surface. The second hinge part 3B includes two axes 3B1 on top and bottom respectively, and a hole 3B2 on one surface. The pivot 3A2 is mounted in the hole 3B2 so that the first and second hinge parts 3A, 3B are hingedly secured together. Further, for a first pair of the first hinge part 3A and the second hinge part 3B, the first hinge part 3A is hingedly secured to a lower corner of the charger 1 and the second hinge part 3B is hingedly secured to a lower corner of the holder 2. For a second pair of the first hinge part 3A and the second hinge part 3B, the first hinge part 3A is hingedly secured to one holder 2 and the second hinge part 3B is hingedly secured to another holder 2.

The holder 2 includes a central, lengthwise groove 21 and an inclined trough 22 on one surface of the groove 21. The trough 22 has one end terminating at a top of the groove 21 and the other end terminating at a bottom of the groove 21. The block member 4 includes a wedge 41 and a peg 42 on a bottom. The peg 42 is inserted into the USB port 12 as a dustproof member when no tablet computer or smartphone is held by the holder 2.

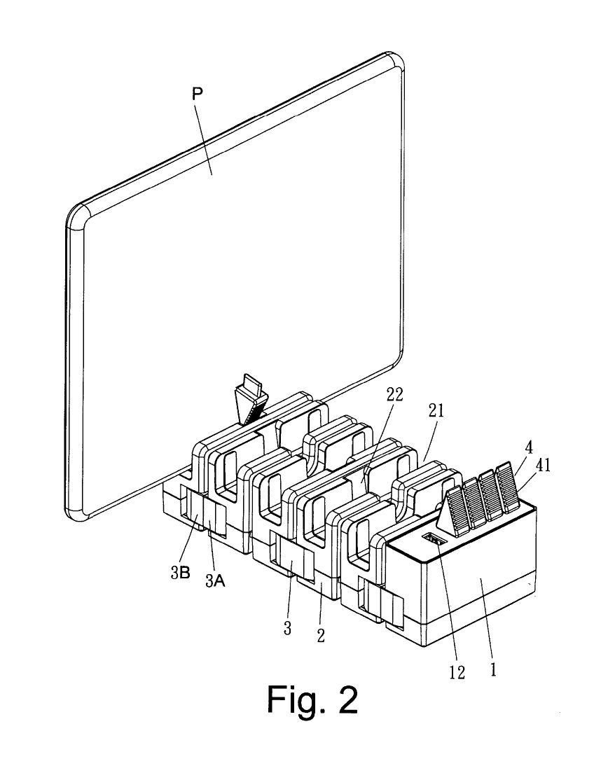

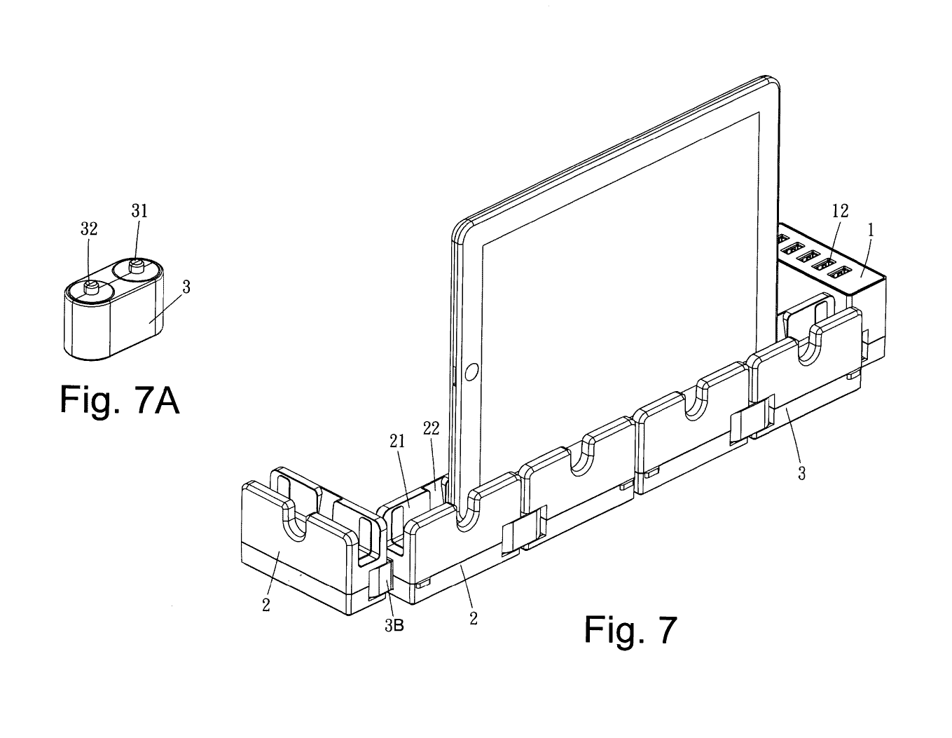

A tablet computer P (or smartphone) can have its lower portion disposed in the groove 21 and the wedge 41 of the block member 4 is inserted into the trough 22 to fasten the tablet computer P (see FIG. 2). Alternatively, the tablet computer P can have its lower portion disposed in the grooves 21 (see FIG. 7). Furthermore, the tablet computer P can be charged by electrically connecting the tablet computer P and the USB port 12.

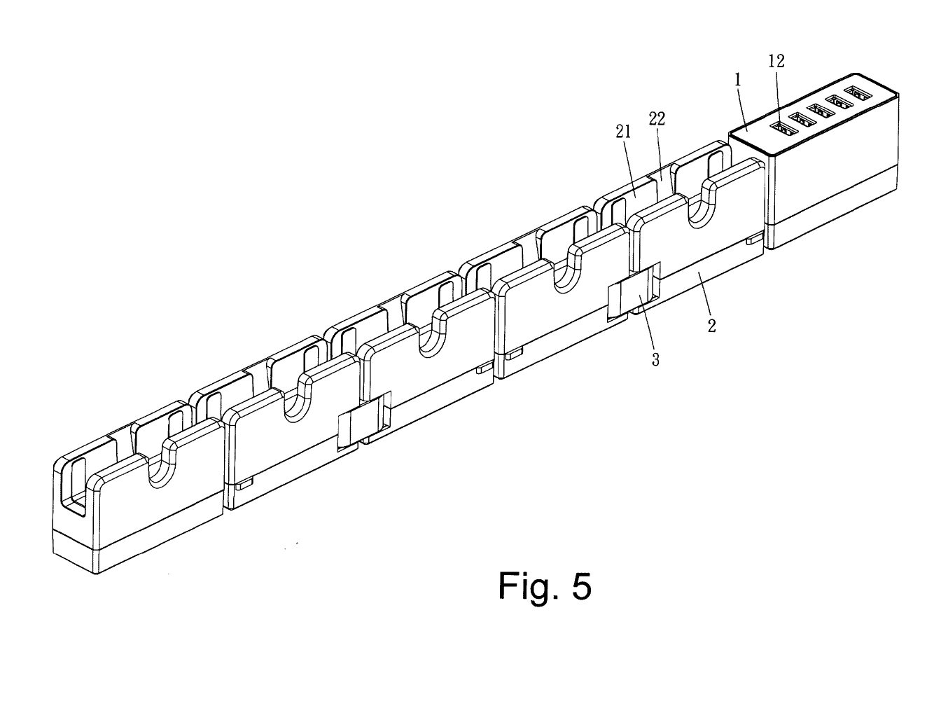

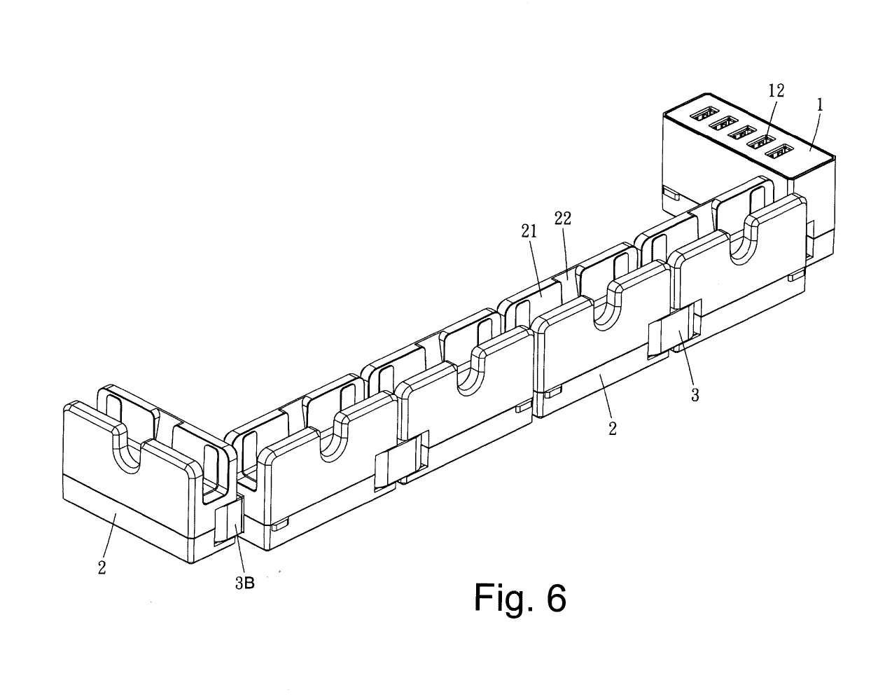

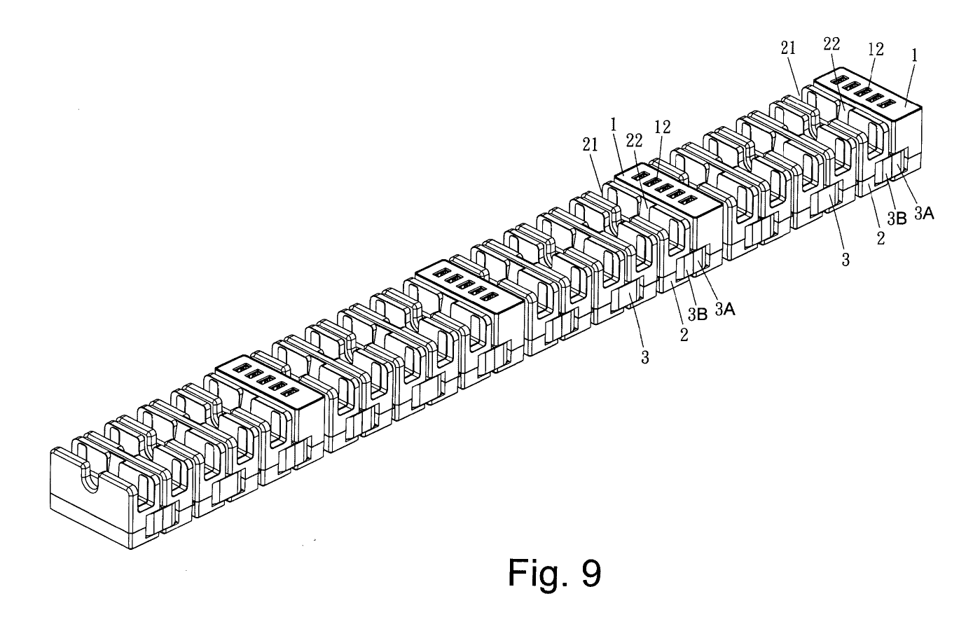

The invention can be arranged in different ways. As shown in FIG. 1, five holders 2 and a charger 1 are arranged as a rectangle. As shown in FIG. 5, five holders 2 and a charger 1 are arranged as an elongated configuration. As shown in FIG. 6, five holders 2 and a charger 1 are arranged as a U. As shown in FIG. 9, four sets of five holders 2 and a charger 1 are arranged as another elongated configuration in which each set of five holders 2 and a charger 1 are arranged as the elongated configuration shown in FIG. 1.

In the arrangement shown in FIG. 7, the holders 2 other than the holder 2 located farthest from the charger 1 can be pivoted about both the distal holder 2 and the charger 1 if an optimum view of angle of the tablet computer P is desired.

While the invention has been described in terms of preferred embodiments, those skilled in the art will recognize that the invention can be practiced with modifications within the spirit and scope of the appended claims.

What is claimed is:

1. A combination storage rack and charger comprising:
a parallelepiped charger including a socket and a plurality of USB (Universal Serial bus) ports;
a plurality of holders each including a central, lengthwise groove and an inclined trough on a surface of the groove;
a plurality of block members each including a peg configured to insert into the USB port;
a plurality of joining members each including two sets of first and second axes wherein the first axes are pivotably secured to the holder and the second axes are pivotably secured to the adjacent holder;
first and second hinges each including a first part having two axes and a pivot, and a second part having two axes and a hole;
wherein the pivot is pivotably disposed in the hole;
wherein the first part of the first hinge is hingedly secured to a corner of the charger and the second part thereof is hingedly secured to a corner of the holder adjacent to the charger; and
wherein the first part of the second hinge is hingedly secured to a corner of the holder and the second part thereof is hingedly secured to a corner of the holder distal the charger.
